(19) United States
(12) Patent Application Publication
(10) Pub. No.: US 2003/0080485 A1
(43) Pub. Date: May 1, 2003

(54) Bar clamp

(76) Inventor: Meei Feng Lo, Taichung City (TW)

Correspondence Address: Keith Kline, PRO-TECHTOR INTERNATIONAL SERVICES, 20775 Norada Court, Saratoga, CA, 95070-3018, US

(21) Appl. No.: 10/039,914

(22) Filed: Oct. 25, 2001

(51) Int. Cl. B25B 1/00

(52) U.S. Cl. 269/6

(57) ABSTRACT

A bar clamp comprises a triangular elastic positioning member sleeved on bar wherein bar is locked by positioning member in an unused position; an abutment plate sleeved on bar being slidable with respect to bar in unused position; a pivotal release lever obliquely extended down from abutment plate and having a pawl-like end; and a ratchet toothed section below the bar engaged with pawl-like end. In one of pressing operations, press the release lever for moving jaws toward each other by disengaging pawl-like end from ratchet toothed section temporarily. In a releasing operation, press the release lever to disengage pawl-like end from ratchet toothed section for unlocking bar prior to sliding the bar.

### FIELD OF THE INVENTION

The present invention relates to bar clamps and more particularly to such a bar clamp with improved characteristics.

### BACKGROUND OF THE INVENTION

U.S. Design Pat. No. 320,919 entitled “Quick Action Bar Clamp” is shown in FIG. 1. The bar clamp comprises a body 10, a channel 13 through body 10, a bar 15 sliding within channel 13, a movable member 14 in body 10 sleeved on bar 15, a movable jaw 111 extended from a front end of bar 15, a fixed jaw 11 extended from body 10 being disposed oppositely to fixed jaw 11, a release lever 19 extended down from fixed jaw 11 being slidingly sleeved on bar 15, a spring 17 put on bar 15, an abutment plate 16 on the front end of spring 17 in body 10, a front pivotal handle 18 obliquely extended down from body 10, and a rear grip handle 12 also obliquely extended down from body 10.

In a pressing operation, user may grip the pivotal handle 18 and grip handle 12 prior to pressing the pivotal handle 18. In response, movable member 14 is pressed rearward which in turn causes both abutment plate 16 and spring 17 to bias. As an end, movable jaw 111 moves rearward with respect to fixed jaw 11. Such pressing may continue until an object is held firmly between jaws 111 and 11. Note that in such pressing operation, bar 15 is allowed to move rearward only. In a releasing operation, user has to press release lever 19 to disengage bar 15 from and within channel 13. Then user may pull movable jaw 111 to increase a distance between movable jaw 111 and fixed jaw 11 since bar 15 is free to slide. Such distance is always equal to or less than a maximum distance between movable jaw 111 and fixed jaw 11.

However, the previous design suffered from a disadvantage. Namely, the release lever 19 which is an additional protruding element. Hence, it not only detracts from its external appearance but also hinders the operation. Thus improvement exists.

### SUMMARY OF THE INVENTION

It is therefore an object of the present invention to provide a bar clamp comprising a body; a channel through the body; a sliding bar in the channel having a front movable jaw; a movable member in the body sleeved on the bar, a fixed jaw extended from the body being disposed oppositely to the movable jaw, a triangular elastic positioning member sleeved on the bar wherein the bar is locked by the positioning member in an unused position; a front pivotal handle obliquely extended down from the body and having a pair of opposite tabs extended inward; an abutment plate sleeved on the bar being slidable with respect to the bar in the unused position; a release lever obliquely extended down from the abutment plate and having a pawl-like end; a first spring interconnecting the release lever and the pivotal handle; a second spring in the movable member biased against the abutment plate; a ratchet toothed section on a lower edge of the body wherein one of teeth thereof is always engaged with the pawl-like end in the unused position; and a rear grip handle obliquely extended down from the body; In one of a plurality of pressing operations, the pivotal handle, the grip handle, and the release lever are operative to press the release lever for comprising the first spring, in response the release lever pivots about the pivotal handle to disengage the pawl-like end from the ratchet toothed section prior to moving rearward one tooth therealong, the second spring is subsequently expanded to push the abutment plate forward until being stopped by the tabs, the bar is unlocked from the compressed positioning member for moving rearward a distance corresponding to a movement of the pawl-like end from one tooth of the ratchet toothed section to the other adjacent rear tooth thereof so as to move the movable jaw rearward with respect to fixed jaw, and a releasing of the release lever locks the bar in the unused position. In a releasing operation, press the release lever to disengage the pawl-like end from the ratchet toothed section for unlocking the bar prior to sliding the bar.

The above and other objects, features and advantages of the present invention will become apparent from the following detailed description taken with the accompanying drawings.

### BRIEF DESCRIPTION OF THE DRAWINGS

FIG. 1 is a side view of a conventional bar clamp;

FIG. 2 is a side view of a preferred embodiment of bar clamp according to the invention in a fully open position with a portion enlarged to show features;

FIG. 3 is a perspective view showing a relationship among pivotal handle, release lever, abutment plate, bar, tabs, and elastic positioning member where release lever is not pressed;

FIG. 4 is a view similar to FIG. 3 where release lever is pressed;

FIG. 5 is another side view of the bar clamp in a completely closed position with a portion enlarged to show features; and

FIG. 6 is a view similar to FIG. 5 where the bar clamp is suitably opened to be ready to hold firmly an object.

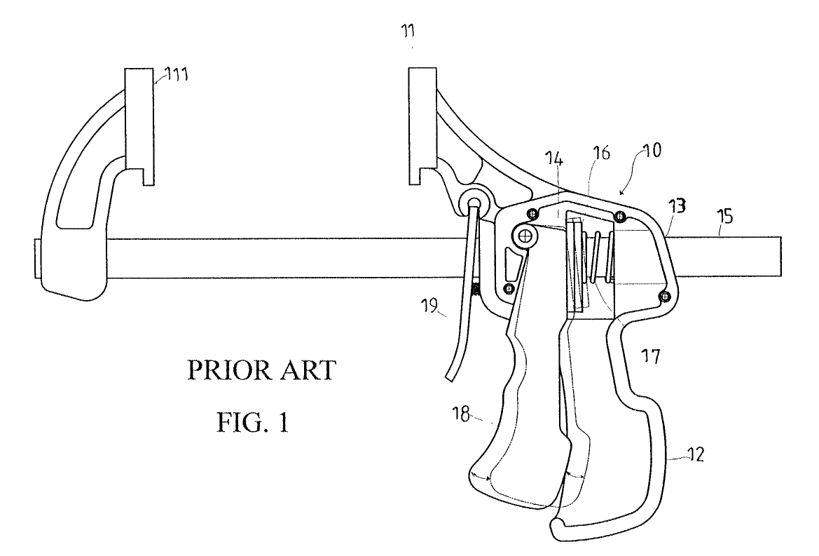

### DETAILED DESCRIPTION OF THE PREFERRED EMBODIMENTS

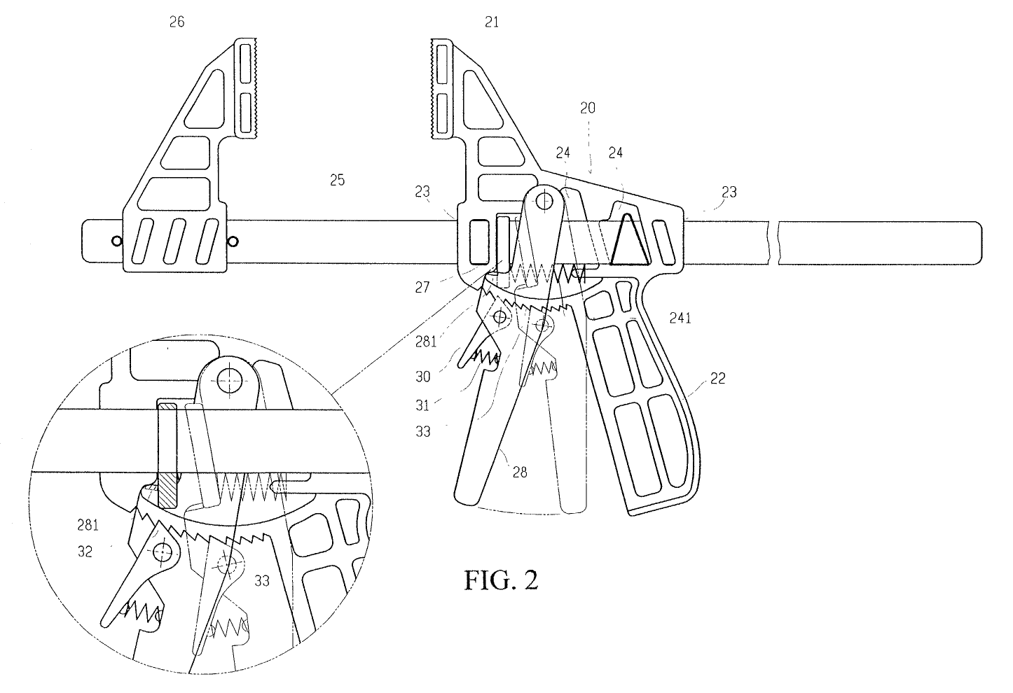

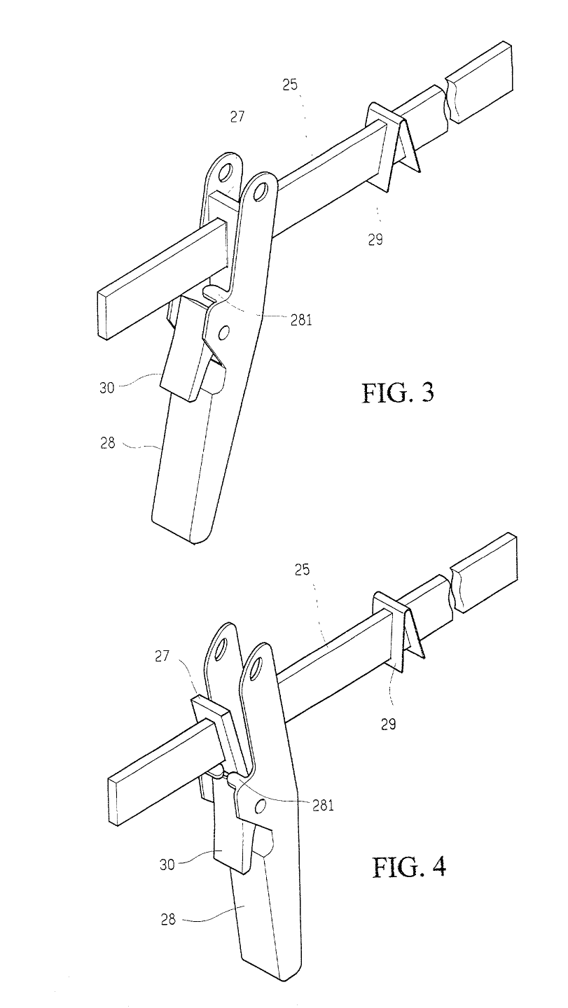

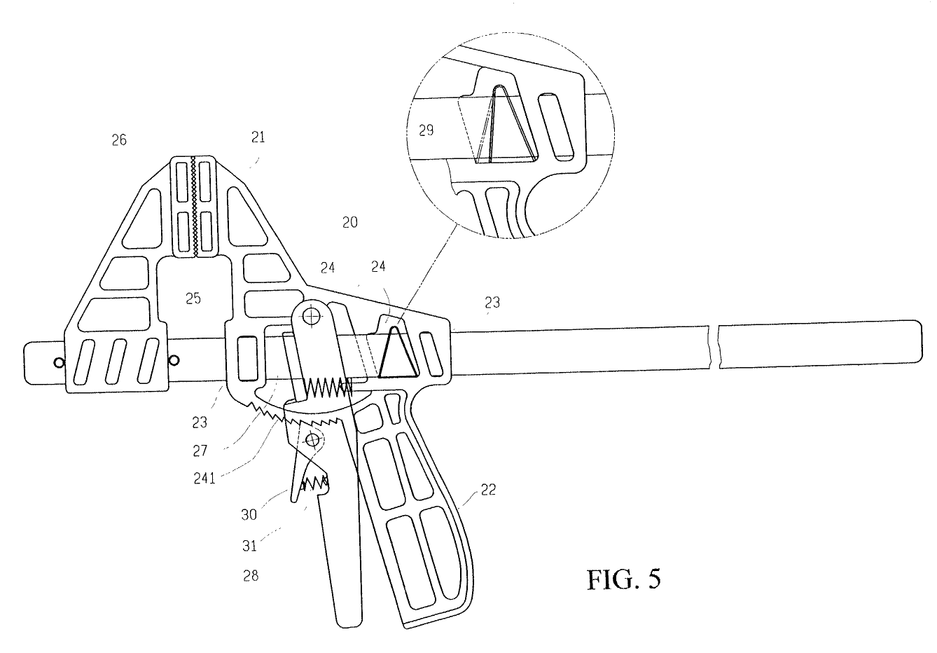

Referring to FIGS. 2 to 6, there is shown a bar clamp constructed in accordance with the invention comprising a body 20, a channel 23 through body 20, a bar 25 sliding within channel 23, a movable member 24 in body 20 sleeved on bar 25, a movable jaw 26 extended from a front end of bar 25, a fixed jaw 21 extended from body 20 being disposed oppositely to movable jaw 26, a triangular elastic positioning member 29 sleeved on bar 25 wherein bar 25 is locked by elastic positioning member 29 in an unused position, a front pivotal handle 28 obliquely extended down from body 20 and having a pair of tabs 281 extended inward toward each other, an abutment plate 27 sleeved on bar 25 and received between a yoke in the top portion of pivotal handle 28 wherein abutment plate 27 is slidable with respect to bar 25 in an unused position, a release lever 30 extended down from and being in an obliqe angle about abutment plate 27, a first spring 31 interconnecting release lever 30 and pivotal handle 28, a second spring 241 in movable member 24 biased against lower part of abutment plate 27, a ratchet toothed section 32 formed on lower edge of body 20 wherein one of teeth thereof is always engaged with a pawl-like end of release lever 30 in an unused position, and a rear grip handle 22 obliquely extended down from body 20.

In a pressing operation, user may grip the pivotal handle 28, grip handle 22, and release lever 30. Once release lever 30 is pressed the first spring 31 is compressed. Hence, release lever 30 pivots about pivotal handle 28 to cause the pawl-like end of release lever 30 to disengage from ratchet toothed section 32 prior to moving rearward one tooth therealong. Also, second spring 241 is expanded to push abutment plate 27 forward until being stopped by tabs 281 (FIG. 4). At the same time, bar 25 is unlocked from elastic positioning member 29 since the compression force on elastic positioning member 29 is sufficiently large. As a result, bar 25 moves rearward a distance corresponding to a movement of the pawl-like end of release lever 30 from one tooth of ratchet toothed section 32 to an adjacent rear tooth thereof. Once release lever 30 is unpressed (i.e., first spring 31 is returned to normal position) bar 25 is locked again by the expansion of elastic positioning member 29 and again bar 25 is unlocked from abutment plate 27 by the compression of second spring 241 as in a normal unused position. Such pressing and unpressing of release lever 30 may continue to move movable jaw 26 rearward with respect to fixed jaw 21 until an object is held firmly between jaws 22 and 21. Note that in such operation, bar 25 is allowed to move rearward only by the nature of ratchet toothed section 32. In view of this, the pressing operation of bar clamp for holding an object is convenient and effective.

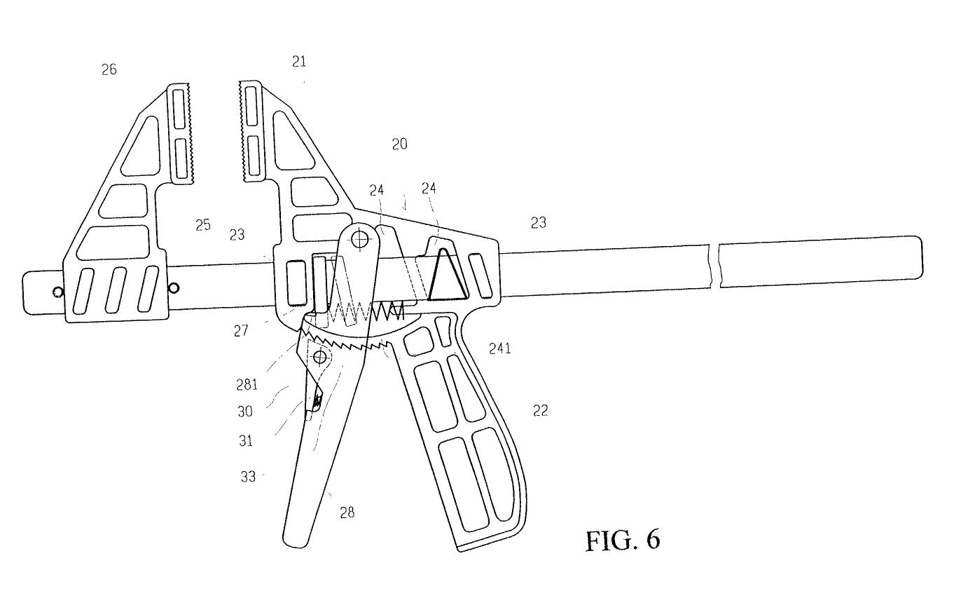

In a releasing operation after a job is done, user may continue to press the release lever 30 to disengage the pawl-like end of release lever 30 from ratchet toothed section 32 for unlocking bar 25 (FIG. 6). Then slide bar 25 to increase a distance between movable jaw 26 and fixed jaw 21 until a desired distance is reached prior to releasing the release lever 30. In view of this, the releasing operation of bar clamp (i.e., returned to unused position) is quick and simple.

While the invention has been described by means of specific embodiments, numerous modifications and variations could be made thereto by those skilled in the art without departing from the scope and spirit of the invention set forth in the claims.

What is claimed is:

1. A bar clamp comprising:
a body;
a channel through the body;
a sliding bar in the channel having a front movable jaw;
a movable member in the body sleeved on the bar,
a fixed jaw extended from the body being disposed oppositely to the movable jaw, a triangular elastic positioning member sleeved on the bar wherein the bar is locked by the positioning member in an unused position;
a front pivotal handle obliquely extended down from the body and having a pair of opposite tabs extended inward;
an abutment plate sleeved on the bar being slidable with respect to the bar in the unused position;
a release lever obliquely extended down from the abutment plate and having a pawl-like end;
a first spring interconnecting the release lever and the pivotal handle;
a second spring in the movable member biased against the abutment plate;
a ratchet toothed section on a lower edge of the body wherein one of teeth thereof is engaged with the pawl-like end in the unused position; and
a rear grip handle obliquely extended down from the body;
wherein in one of a plurality of pressing operations, the pivotal handle, the grip handle, and the release lever are operative to press the release lever for comprising the first spring, in response the release lever pivots about the pivotal handle to disengage the pawl-like end from the ratchet toothed section prior to moving rearward one tooth therealong, the second spring is subsequently expanded to push the abutment plate forward until being stopped by the tabs, the bar is unlocked from the compressed positioning member for moving rearward a distance corresponding to a movement of the pawl-like end from one tooth of the ratchet toothed section to the other adjacent rear tooth thereof so as to move the movable jaw rearward with respect to fixed jaw, and a releasing of the release lever locks the bar in the unused position; and in a releasing operation, press the release lever to disengage the pawl-like end from the ratchet toothed section for unlocking the bar prior to sliding the bar.
